(19) United States
(12) Patent Application Publication
(10) Pub. No.: US 2011/0119632 A1
(43) Pub. Date: May 19, 2011

(54) SYSTEMS AND METHODS FOR STORING, RETRIEVING, AND SHARING DESIGN AND CONSTRUCTION DATA

(76) Inventor: Drone Iyangar, Los Angeles, CA (US)

(21) Appl. No.: 12/905,016

(22) Filed: Oct. 14, 2010

Related U.S. Application Data
(63) Continuation of application No. 11/733,920, filed on Apr. 11, 2007.
(60) Provisional application No. 60/744,747, filed on Apr. 13, 2006.

(51) Int. Cl. G06F 3/048

(52) U.S. Cl. 715/849

(57) ABSTRACT

This invention relates generally to construction, and more specifically, to systems and methods for storing, retrieving, and sharing data relating to construction data employing maps, diagrams, and three-dimensional objects as an organizational matrix. In one embodiment, the invention includes a scalable graphical matrix, the scalable graphical matrix being a visual representation of a project that progresses from design through actualization, the visual representation being visually explorable at different scales; a data repository, the data repository storing project data, the project data being visually associated to the scalable graphical matrix; and a user interface, the user interface configurable to access and store the project data using the scalable graphical matrix. In one particular embodiment, the project is a building construction project.

### PRIORITY CLAIM

This application is a continuation application of U.S. application Ser. No. 11/733,920 filed Apr. 11, 2007, which application is a non-provisional of U.S. Application Ser. No. 60/744,747 filed on Apr. 13, 2006. This application claims the benefit and/or priority to each of the foregoing applications. The foregoing applications are incorporated by reference in their entirety as if fully set forth herein.

### FIELD OF THE INVENTION

This invention relates generally to construction, and more specifically, to systems and methods for storing, retrieving, and sharing construction data employing maps, diagrams, and three-dimensional objects as an organizational matrix.

### BACKGROUND OF THE INVENTION

Construction is a multi-billion dollar industry in the United States and around the World. Construction projects range from houses, apartments, factories, offices, schools, roads, and bridges to name just a few. Activities include building new structures, additions to structures, and modifications to existing structures. Whether it is a large downtown skyscraper or a single family dwelling, each construction project involves a number of individuals and organizations that work together to achieve a successful end result. These individuals and organizations typically include, but are not limited to, an owner, architect, builders, project manager, landscapers, public citizens, and lawyers. These individuals and organizations each contribute skills and information to the project that must be effectively and efficiently communicated among one another to achieve a successful end result.

A typical construction project will proceed from an owner's idea. The owner brings the idea to a design professional, such as an architect, who assists the owner in reducing the idea to a set of drawings and specifications. The owner and design professional then solicit bids from builders for actualizing the idea as set forth in the drawings and specifications. The builders use the information contained in the drawings and specifications to solicit sub-bids from specialty sub-contractors. With sub-bids in hand, the builders submit general bids to the owner and design professional, who then evaluate bids and select a winning proposal. Throughout this process, lawyers are involved in creating bid proposals and numerous clarifications are communicated among the owner, design professional, builders, and sub-contractors. Once a project is awarded, the builder proceeds with construction by organizing the sub-contractors, suppliers, and information while managing government inspections and requests for clarifications or changes to the drawings and specifications. Quite apparently, even with a simple construction project there is an enormous volume of information that must be efficiently and effectively managed and communicated among involved parties.

The complexity is compounded as the project size grows, the number of projects increases, or the number of parties involved increases. For instance, design and construction of larger and more specialized projects will involve parties spread in different geographical regions of the world based on their specialty, making efficient and effective communication more difficult. Further, when various data is needed for public use, such as for commercial or research purposes, the number of additional parties similarly makes efficient and effective communication more difficult.

Current systems for managing construction project information include software applications employing customary file folder organizational methods. Generally, a file folder is created for each construction project, and within the file folder are sub-folders for various data for different aspects of the project. For instance, the main file folder may include a legal folder, a bid submission folder, drawings folder, specifications folder, picture folder, and so on with further sub-folders being common. Current systems also often permit sharing of project information within file folders among numerous individuals and organizations involved in a project. In this manner, various individuals are able to contribute project information to file folders and retrieve project information contained therein.

The current systems are inefficient in many respects given their unintuitive nature and laboriousness. First, current systems are unintuitive in nature because they organize project information within a hierarchical file structure whereas the project information, for example surveys, zoning regulations, floorplan measurements, materials, bids, landscape depictions, foliage samples, conduit layouts, and lighting plans, are associated with visual maps, diagrams, and three-dimensional objects. The disjunction between the visual nature of the project information and the hierarchical organizational method creates a translational burden that is borne by current system users. Second, current systems are laborious because users are required to constantly remove project information from its visual context, traverse hierarchical file structures, locate the project information within files, and re-associate the project information with its visual context. The process becomes even more laborious as a project size grows and the number of projects increases.

Although desirable results have been achieved, there is room for significant improvement. What is needed, therefore, are systems and methods for storing, retrieving, and sharing construction data employing maps, diagrams, and three-dimensional objects as an organizational matrix.

### SUMMARY OF THE INVENTION

This invention relates generally to construction, and more specifically, to systems and methods for storing, retrieving, and sharing data relating to construction data employing maps, diagrams, and three-dimensional objects as an organizational matrix. In one embodiment, the invention includes a scalable graphical matrix, the scalable graphical matrix being a visual representation of a project that progresses from design through actualization, the visual representation being visually explorable at different scales; a data repository, the data repository storing project data, the project data being visually associated to the scalable graphical matrix; and a user interface, the user interface configurable to access and store the project data using the scalable graphical matrix. In one particular embodiment, the project is a building construction project.

### BRIEF DESCRIPTION OF THE DRAWINGS

Embodiments of the present invention are described in detail below with reference to the following drawings:

FIG. 1 is a software application for storing, retrieving, and sharing construction data, in accordance with an embodiment of the invention;

FIG. 2 is a method for storing, retrieving, and sharing construction data, in accordance with an embodiment of the invention;

FIG. 3 is a system for storing, retrieving, and sharing construction data, in accordance with an embodiment of the invention; and

APPENDIX A includes screenshots of a user interface illustrating various scales of a scalable graphical matrix and associated data, in accordance with various embodiments of the invention. The user interface depicted is by way of example and may be altered for user preferences, display constraints, technology improvements, layout changes, or for any other reason or purpose.

### DETAILED DESCRIPTION

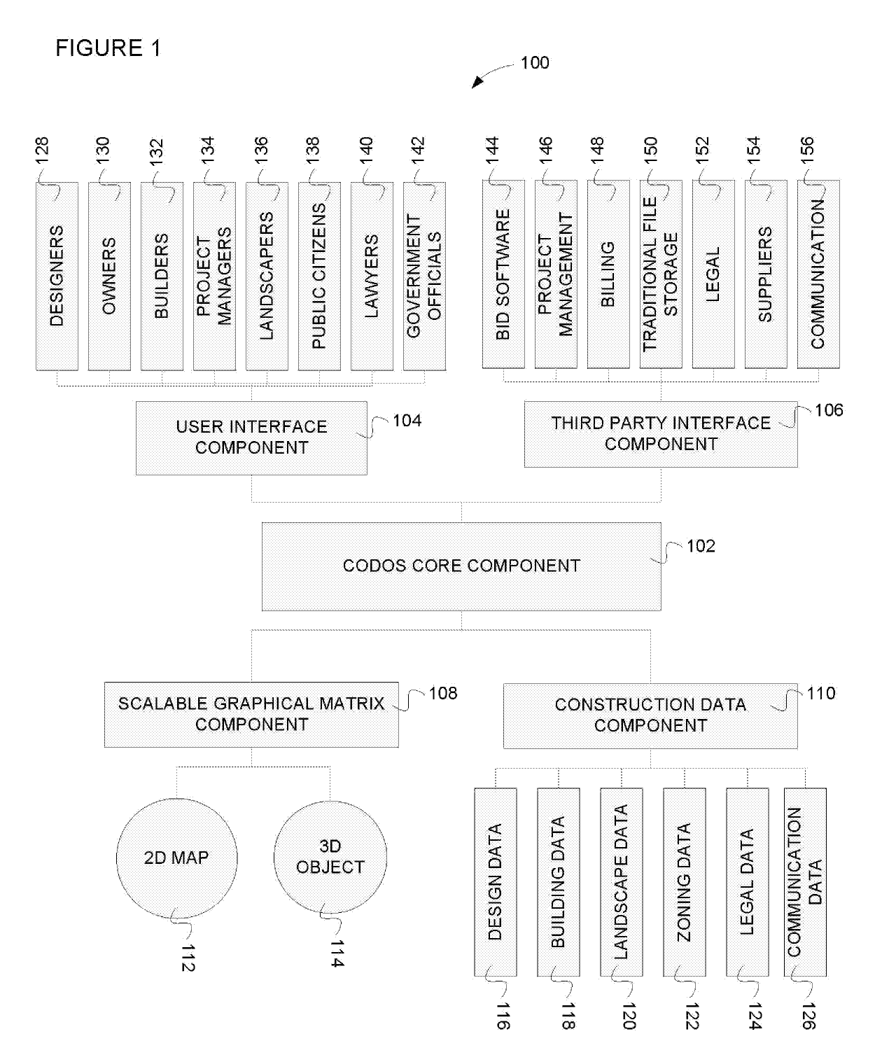

This invention relates generally to construction, and more specifically, to systems and methods for storing, retrieving, and sharing construction data employing maps, diagrams, and three-dimensional objects as an organizational matrix. Specific details of certain embodiments of the invention are set forth in the following description and in FIGS. 1-3 and APPENDIX A to provide a thorough understanding of such embodiments. The present invention may have additional embodiments, may be practiced without one or more of the details described for any particular described embodiment, or may be practiced with any combination of the details described for any particular embodiment.

FIG. 1 is a software application for storing, retrieving, and sharing construction data, in accordance with an embodiment of the invention. In one embodiment, software application 100 includes a construction documents organization system (CODOS) core component 102. In certain embodiments, the CODOS core component 102 includes any of a user interface component 104, 3^{rd} party interface component 106, scalable graphical matrix component 108, and construction data component 110.

In one embodiment, the scalable graphical matrix component 108 is comprised of a plurality of visual depictions, such as a two-dimensional map 112 and a three-dimensional object 114. In one embodiment, the visual depictions include any of a world map, country map, state map, county map, city map, zone map, site map, building map, interior space map, a computer aided drawing (CAD), movie, and an image. The visual depictions are utilized to provide a scalable graphical matrix, wherein a given construction project is capable of being visually depicted at various perspectives and scales. Thus, a user is permitted to zoom in, zoom out, rotate about, and otherwise visually explore a given construction project. In this regard, the scalable graphical matrix permits a user to explore an interior design, a landscape design, a building site, a land survey, a street, a drainage line, an electrical layout, and zoning areas. In further embodiments, the scalable graphical matrix component 108 is configured to permit similar visual exploration of multiple construction projects.

In another embodiment, the construction data component 110 is configured to organize construction data and relationships between the construction data and the scalable graphical matrix. In certain embodiments, the construction data is categorized according to, but not limited to, any of design data 116, building data 118, landscape data 120, zoning data 122, legal data 124, and communication data 126. Specific construction data within these broad categories may include, for example, a survey, zoning regulations, a schedule, a drawing, a site plan, a drainage plan, a paving plan, a floor plan, an electrical conduit layout, a lighting plan, and a flooring plan. In one particular embodiment, the particular construction data is further organized according to the category, a discipline, and a data type. For instance, the zoning regulations may be organized within zoning as the category, within architecture as the discipline, and within document as the data type. Further, the electrical conduit layout may be organized within building as the category, within electrical contractor as the discipline, and within drawing as the data type. In further embodiments, the relationships between the construction data and the scalable graphical matrix include an associated scale level and a particular coordinate on the scalable graphical matrix. For instance, the flooring plan construction data may be associated with the interior space scale level at coordinates visually associated with a kitchen on the scalable graphical matrix.

In a further embodiment, the user interface component 104 provides access to the construction data organized through the scalable graphical matrix. The user interface component 104 permits viewing of a particular construction project at various perspectives and scales through the scalable graphical matrix. Thus, a user can zoom in, zoom out, rotate about, and otherwise visually explore a construction project through the user interface component 104. The construction data is visually present on the scalable graphical matrix, thereby intuitively relating the construction data to the scalable graphical matrix as viewed through the user interface component 104. For instance, zoning regulation documents may be visually present at the zone level of the scalable graphical matrix. Further, building-wide electrical conduit layout diagrams may be visually present at the building level of the scalable graphical matrix. In one particular embodiment, the construction data is represented on the scalable graphical matrix as a symbol and the symbol is activated, such as by a mouse-click, to produce the construction data associated with the symbol. For example, to locate a drawing with details and measurements for the furniture layout inside a certain part of a building on a construction project, a user accesses the user interface component 104 and visually zooms through the county, city, zone, site, and building scales to the interior space scale of the scalable graphical matrix. At the space scale, the user rotates and slides about to the desired interior area. The user clicks the symbol representing the drawing, and the drawing with details and measurements is retrieved from the construction data component 110 and produced on the user interface component 104. In another particular embodiment, the user interface component 104 is configurable to provide a plurality of windows, each of which is capable of depicting unique scales or perspectives of the scalable graphical matrix. Thus, instead of zooming in and zooming out, various scales of the scalable graphical matrix are accessible by opening and closing windows associated with the particular scales.

In yet another embodiment, the user interface component 104 is configured to accept construction data for storage in the construction data component 110 by placing the construction data on a desired location of the scalable graphical matrix. For instance, a user having a legal contract pertaining to plumbing for a construction project can store the contract in the construction data component 110 by placing the contract on the plumbing present on the scalable graphical matrix. In certain embodiments, the construction data accepted for storage is retrievable using the scalable graphical matrix as discussed in previous embodiments.

In further embodiments, the user interface component 104 is customizable according to needs of any of designers 128, owners 130, builders 132, project managers 134, landscapers 136, public citizens 138, lawyers 140, and government officials 142. The customizing includes any of limiting access to areas of the scalable graphical matrix; defaulting to particular scales of the scalable graphical matrix; limiting view, change, or delete authorizations for construction data; and defaulting to categories, disciplines, or types of construction data. In one particular embodiment, the user interface component 104 is configured for use by public citizens, wherein the public citizens are permitted to store, access, and view construction data using the scalable graphical matrix as an organizational tool. Further, the public citizens in certain embodiments are permitted to explore various areas of the scalable graphical matrix to track construction progress. Security may be present to filter available construction data and to limit access to various areas of the scalable graphical matrix. For example, public citizens may be condominium purchasers and can use the user interface component 104 and the scalable graphical matrix to track accessible construction data and place offers on particular units of interest. Alternatively, public citizens may be neighborhood property owners who can use the user interface component 104 and the scalable graphical matrix to track proposed land use and construction progress. Other public citizen uses are within the scope of the invention.

In another embodiment, the third party interface component 106 provides a data interface between the CODOS core component 102 and various third party applications. In certain embodiments, the various third party applications include, but are not limited to, bid software 144, project management software 146, billing software 148, traditional file storage software 150, legal software 152, supplier software 154, and communication software 156. Thus, construction data accessible in various third party applications is importable and usable within the CODOS core component 102 and construction data accessible in the CODOS core component 102 is exportable and usable in various third party applications.

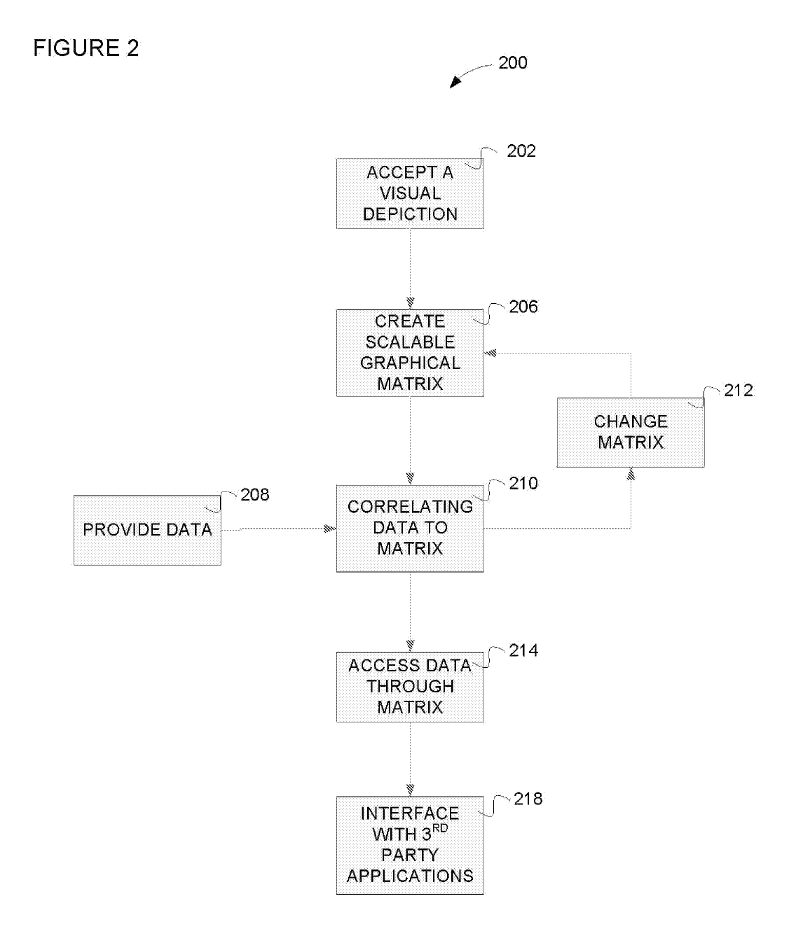

FIG. 2 is a method for storing, retrieving, and sharing construction data, in accordance with an embodiment of the invention. In one embodiment, the method 200 includes accepting a visual depiction at block 202, creating a scalable graphical matrix at block 206, accepting data at block 208, correlating the data to the scalable graphical matrix at block 210, and accessing the data through the scalable graphical matrix. In one particular embodiment, the method 200 further includes changing the scalable graphical matrix at block 212, and re-correlating the data to the changed scalable graphical matrix at block 210. In yet another particular embodiment, the method 200 further includes interfacing with a third party application at block 218.

In one embodiment, the accepting of a visual depiction at block 202 includes accepting a plurality of any of a map, image, movie, CAD, diagram, flow chart, or other visual depiction of a particular construction project or group of construction projects, the plurality of visual depictions being generally of different scales or perspectives. Thus, the plurality of visual depictions in case of a construction project, may include any of a world map, a country map, a state map, a county map, a city map, a zone map, a building site map, a building Computer Aided Drawing, an interior picture, and landscaping movie.

In another embodiment, the creating a scalable graphical matrix at block 206 includes using the one or more visual depictions to provide a unified, scalable visual representation of a particular construction project or group of construction projects. Thus, in certain embodiments, the scalable graphical matrix permits visual exploration of a zoning map, landscape design, a building interior, and an electrical layout map at different scales and various perspectives. In one embodiment, the visual exploration is continuous and includes any of zooming in, zooming out, and panning about. In another embodiment, the visual exploration is discrete and includes separate visual depictions for each scale level and perspective. In certain embodiments, the separate visual depictions are organized in a tabular format.

In yet another embodiment, the accepting data at block 208 includes accepting construction data pertaining to a particular construction project or group of construction projects. The construction data may include any document, image, message, movie, drawing, report, tests, or any other type of data that is useful for construction. In certain embodiments, the construction data is organized by category, discipline, and type. For instance, an interior drawing of a particular building may have design as the category, architecture as the discipline, and drawing as the type. Fewer or greater organizational methods are employable.

In a further embodiment, the correlation of the data to the scalable graphical matrix includes associating the accepted construction data to a coordinate on the scalable graphical matrix for which the construction data relates. In one particular embodiment, the association includes placing an icon representative of the construction data on the scalable graphical matrix. Thus, construction data regarding a plumbing report may be associated with the scalable graphical matrix on the plumbing for which it relates using a document-type icon. In one embodiment, any number of construction data is associable with the scalable graphical matrix at any scale or perspective. Thus, a plurality of construction data may be present at a space level, a floor plan level, a building level, a site level, a zone level, a city level, and a county level. Certain construction data may be present on multiple scale levels and is optionally filterable, such as by category, discipline, and type.

In yet a further embodiment, the accessing data through the scalable graphical matrix at block 214 includes using the scalable graphical matrix to locate and retrieve relevant data desired. In one particular embodiment, the using the scalable graphical matrix includes visually locating an area on the scalable graphical matrix for which the desired construction data relates, finding an icon around the area representing the desired construction data, and activating the icon to retrieve the desired construction data. For instance, accessing a plumbing report may include locating plumbing on the scalable graphical matrix for which the plumbing report related, finding a document-type icon on the plumbing, and clicking on the icon to retrieve the plumbing report.

In an alternative embodiment, the method 200 further includes the changing the scalable graphical matrix at block 212 and re-correlation of the data to the scalable graphical matrix. Construction designs, layouts, landscaping, and zoning often change over time, and the scalable graphical matrix integrates these changes as desired. With the changes to the scalable graphical matrix, certain construction data may need to be re-correlated on the changed scalable graphical matrix. For instance, if a plumbing layout is relocated, the plumbing report associated with the former plumbing layout may need to be re-correlated with the relocated plumbing layout. In certain embodiments, the method 200 alerts or requests the re-correlation.

In another embodiment, the method 200 further includes the interfacing with a third party application. The third party application may include any of construction bid software, project management software, billing software, traditional file storage software, legal software, supplier software, communication software, or any application that uses or contains construction data. The interfacing may include accepting data from the third party application at block 208 or providing data to the third party application.

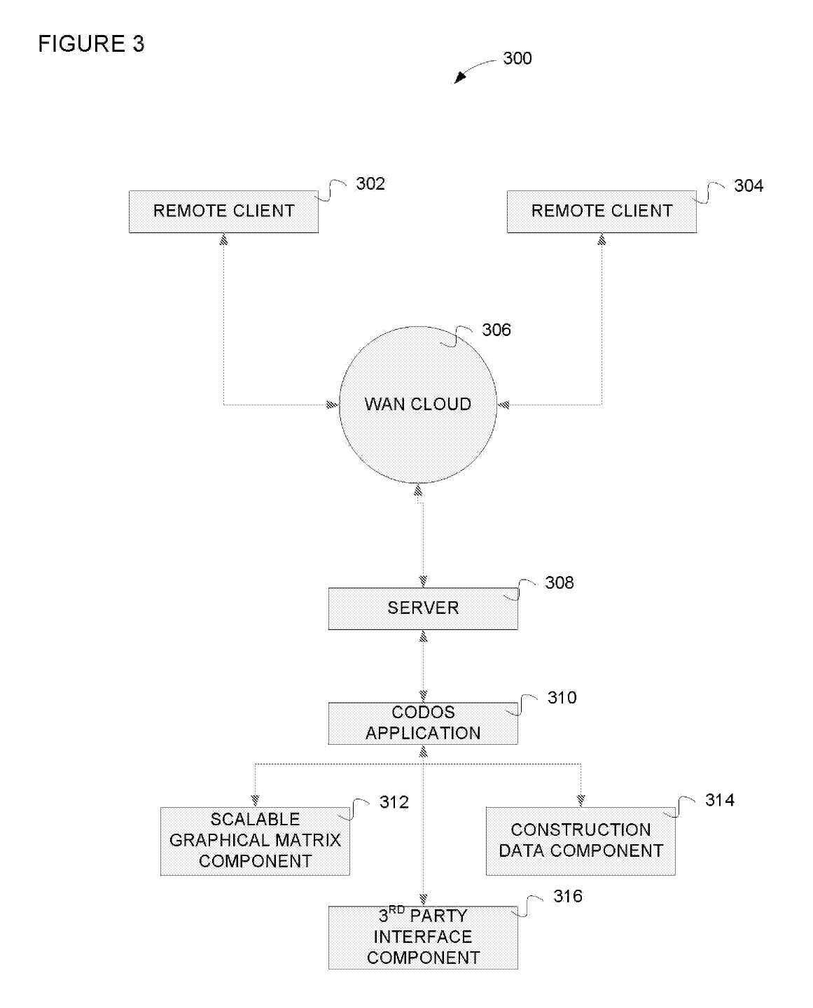

FIG. 3 is a system for storing, retrieving, and sharing construction data, in accordance with an embodiment of the invention. In one embodiment, system 300 includes at least one remote client 302 and a server 308 hosting a construction document organization system (CODOS), in communication over a WAN cloud 306. In certain embodiments, the system 300 further includes at least one additional remote client 304 in communication with the server 308 over the WAN cloud 306.

In one embodiment, the CODOS 310 includes any of the embodiments discussed in relation to FIG. 1 and implements any of the embodiments discussed in relation to FIG. 2. Thus, in certain embodiments, the CODOS 310 includes a scalable graphical matrix component 312, a construction data component 314, and/or a third party interface component 316. The scalable graphical matrix component 312 provides a scalable graphical matrix of a construction project or group of construction projects, an explorable visual representation of the construction project or group of construction projects at various scales or perspectives. The construction data component 314 stores any type of data associated with the construction project or the group of construction projects. The construction data stored within the construction data component 314 is associated visually on the scalable graphical matrix.

In another embodiment, the remote client 302 provides a user interface configurable to communicate with the CODOS application 310 through the WAN cloud 306. The user interface permits visual exploration of the scalable graphical matrix 312 and the construction data organized thereon. In one embodiment, the user interface permits association of construction data on the scalable graphical matrix. In another embodiment, the user interface permits retrieval of construction data using the scalable graphical matrix.

In yet another embodiment, the WAN cloud 306 includes any network medium including internet, a local area network, satellite, cellular, or point-to-point communication. In yet a further embodiment, the remote client 302 is accessible on the server 308. In alternative embodiments, components of the CODOS application 310 are distributed among a plurality of servers.

While preferred and certain alternate embodiments of the invention have been illustrated and described, as noted above, many changes can be made without departing from the spirit and scope of the invention. For instance, although reference has been made to utilizing the systems and methods described herein in the particular context of construction projects, the systems and methods are also employable in context of any project that progresses from design through actualization that is visually expressible, such as automobile, software, business process, or machine design or construction. In these embodiments, the design is the scalable graphical matrix for which relating data is organized. Accordingly, the scope of the invention is not limited by the disclosure of these preferred and alternate embodiments. Instead, the invention should be determined entirely by reference to the claims that follow.

What is claimed is:

1. A system comprising:
a user interface component configured to accept one or more data files;
a memory component configured to store the one or more data files with one or more references to one or more existing objects of one of more three-dimensional graphical representations,
wherein the user interface is configured to provide access to the one or more data files via one or more links that are displayable in close association with the one or more objects of the one or more three-dimensional graphical representations.

2. The system of claim 1, wherein the user interface component configured to accept one or more data files comprises:
a user interface component configured to accept one or more text, image, and/or movie files.

3. The system of claim 1, wherein the user interface component configured to accept one or more data files comprises:
a user interface component configured to accept one or more data files containing information that is independent from data used to render the one or more three-dimensional graphical representations.

4. The system of claim 1, wherein the memory component configured to store the one or more data files with one or more references to one or more existing objects of one of more three-dimensional graphical representations comprises:
a memory component configured to store the one or more data files with one or more references to one or more existing objects of one of more three-dimensional graphical representations, the one or more data files containing information relating to two or more objects of the one or more three-dimensional graphical representations.

5. The system of claim 1, wherein the memory component configured to store the one or more data files with one or more references to one or more existing objects of one of more three-dimensional graphical representations comprises:
a memory component configured to store the one or more data files with one or more references to one or more existing objects of one of more three-dimensional graphical representations in accordance with one or more indications on the one or more three-dimensional graphical representations.

6. The system of claim 1, wherein the user interface configured to provide access to the one or more data files via one or more links that are displayable in close association with the one or more objects of the one or more three-dimensional graphical representations comprises:
wherein the user interface is configured to provide access to the one or more data files via one or more links that are displayable in close association with the one or more objects of the one or more three-dimensional graphical representations at one or more different scale levels and/or perspectives.

7. The system of claim 1, wherein the user interface configured to provide access to the one or more data files via one or more links that are displayable in close association with the one or more objects of the one or more three-dimensional graphical representations comprises:
wherein the user interface is configured to provide access to the one or more data files via one or more links that are displayable in close association with the one or more objects of the one or more three-dimensional graphical representations based upon a scale level and/or perspective.

8. The system of claim 1, wherein the user interface configured to provide access to the one or more data files via one or more links that are displayable in close association with the one or more objects of the one or more three-dimensional graphical representations comprises:
wherein the user interface is configured to provide access upon authentication to the one or more data files via one or more links that are displayable in close association with the one or more objects of the one or more three-dimensional graphical representations.

9. The system of claim 1, wherein the user interface configured to provide access to the one or more data files via one or more links that are displayable in close association with the one or more objects of the one or more three-dimensional graphical representations comprises:
wherein the user interface is configured to provide access to the one or more data files via one or more links that are displayable in close association with the one or more objects of the one or more three-dimensional graphical representations depending upon access level.

10. The system of claim 1, wherein the user interface configured to provide access to the one or more data files via one or more links that are displayable in close association with the one or more objects of the one or more three-dimensional graphical representations comprises:
wherein the user interface is configured to provide access to the one or more data files via one or more links that are filterably displayable in close association with the one or more objects of the one or more three-dimensional graphical representations based upon a selected category and/or professional discipline.

11. The system of claim 1, wherein the user interface configured to provide access to the one or more data files via one or more links that are displayable in close association with the one or more objects of the one or more three-dimensional graphical representations comprises:
wherein the user interface is configured to provide access to the one or more data files via one or more links that are displayable in close association with the one or more objects of the one or more three-dimensional graphical representations within two or more independently manipulatable windows.

12. The system of claim 1, wherein the user interface configured to provide access to the one or more data files via one or more links that are displayable in close association with the one or more objects of the one or more three-dimensional graphical representations comprises:
wherein the user interface configured to provide access to the one or more data files via one or more links that are displayable in close association with the one or more objects of the one or more three-dimensional graphical representations, appearance of the one or more links being tailored to the one or more data file types.

13. The system of claim 1, further comprising
wherein the user interface is configured to provide one or more alerts upon modification, movement, and/or removal of the one or more existing objects of the one or more three-dimensional graphical representations.

14. A method, the method comprising operations of:
accepting one or more text, image, and/or movie files containing information that is independent from data used to render one or more three-dimensional graphical representations;
storing the one or more data files with one or more references to one or more existing objects of the one or more three-dimensional graphical representations in accordance with one or more indications on the one or more three-dimensional graphical representations; and
providing access to the one or more data files via one or more links that are filterably displayable in close association with the one or more objects of the one or more three-dimensional graphical representations based upon a selected category and/or professional discipline and based upon a scale level and/or perspective, appearance of the one or more links being tailored to the one or more file types; and
providing one or more alerts upon modification, movement, and/or removal of the one or more existing objects of the one or more three-dimensional graphical representations,
wherein the method is implemented by one or more computer executable instructions embodied in one or more computer readable media.

15. A method, the method comprising operations of:
storing one or more references of one or more data files with one or more objects of one or more three-dimensional graphical representations; and
providing access to the one or more data files via the one or more objects of the one or more three-dimensional graphical representations,
wherein the one or more data files contain information that is independent from data used to render the one or more three dimensional graphical representations and
wherein one or more operations of the method are implementable by one or more computer executable instructions embodied in one or more computer readable media.
